(19) United States
(12) Patent Application Publication
(10) Pub. No.: US 2002/0165907 A1
(43) Pub. Date: Nov. 7, 2002

(54) System and method for real time interactive network communications

(76) Inventors: Matthew Dornquast, Stillwater, MN (US); Hugh Cumming, Toronto (CA); Brian Bispala, Minneapolis, MN (US); Mitch Coopet, Savage, MN (US)

Correspondence Address: Mark B. Eisen, Dimock Stratton Clarizio, 20 Queen Street West, Suite 3202, Box 102, Toronto, ON, M5H 3R3, CA

(21) Appl. No.: 09/833,792

(22) Filed: Apr. 13, 2001

(51) Int. Cl. G06F 15/16

(52) U.S. Cl. 709/203; 709/224

(57) ABSTRACT

A web application event framework which allows for robust, fully functional web-enabled applications based on real-time interactivity. A web server creates proxies which establish persistent listening objects between a web browser and an application server. The web browser hosts the listener application, as well as a publisher application and the web application event framework, preferably in different HTML frames. Upon request from a user, the web application event framework start controller creates a session object which establishes a persistent connection between the web browser and the web server and maintains a session state. The session object creates one or more application instance objects, which maintain an application state specific to the functionality of the application. The web application event framework application creates a listener to listen for a specific set of events, and each event is published to the web server through the established session object connection. The listener frame receives the event and notifies the application frame that an event has occurred, and the application code executes appropriate script to notify the user that the event has occurred. Events are published from a web application event framework application by a user submitting an event in the web environment. The event data is interpreted by the web server and passed to the web application event framework generator on the application server, which creates web application event framework events for all users who have established a listener relating to the application in which the event has occurred and delivers these events to the users through the application listener.

### FIELD OF INVENTION

This invention relates to computer network communications. In particular, this invention relates to a system and method for communicating data generated or acquired by computer application programs, especially web-based applications, to multiple remote users in real time.

### BACKGROUND OF THE INVENTION

The ability for a business to access, process and distribute information to customers, suppliers, business partners, investors and employees as quickly and efficiently as possible is often an important factor in the successful operation of the business.

Many businesses outsource various web-enabled applications to third party Application Service Providers (ASPs), which assume responsibility for hosting, managing and supporting the businesses' web-based applications. The business pays a monthly fee for both the use of the application software and the services provided by the ASP. This allows the business to take advantage of technology experts associated with the ASP, which can be difficult to hire and expensive to maintain in-house. Also, the ASP can usually provide such services more efficiently, economies of scale being available because the services are provided for multiple clients. However, many larger businesses still prefer to host their own web-based applications, which gives them a competitive advantage and avoids concerns such as reliability of the information managed by an ASP and maintaining the security of confidential information.

However, in any current web-based application there is a latency, or lag, between the generation or acquisition of information by an application and its dissemination to all relevant remote computers. Most of today's web-based applications are designed for content management and are not intended to deliver interactive, multi-user real-time functionality.

The concept of “zero latency,” which means the true real-time communication of information, is an important step toward the efficient and effective utilization of information by an enterprise. In a zero latency system, as soon as data is captured it is delivered across an enterprise's computer systems, so that by the end of the transaction is present on all relevant remote computers, both internal as well as customers, suppliers and other entities with which the business interacts. Benefits include meeting increased customer expectations, automating transactions, and the ability to make immediate use of important information.

Also, web-based business applications currently available are typically “batchbased,” which means that information changes only during scheduled or requested refresh intervals. Such information is typically acquired in a classical “connect-request-receive-close” loop, which is a user-based search architecture. There is an inherent latency interval in such a system, because the user cannot know when new information has become available. In order to approximate real-time information exchange, the user must frequently “poll” the source server, whether or not any information has changed. Further, each time the user polls the source server the batch delivery system of the prior art transmits an entire new page to replace the earlier page, even if none or very little of the page content has changed. With multiple users, this quickly becomes an unnecessary drain on the capacity of the system.

The constant opening and closing of the communications link, the lack of true “real-time” data exchange, the delivery of redundant data and frequent unnecessary information requests, ultimately waste time and the enterprise's resources. The elimination of these inefficiencies in web-based applications would accordingly promote more efficient and effective communication of information, both within an enterprise and between the enterprise and its trading and business partners.

### SUMMARY OF THE INVENTION

The present invention overcomes these disadvantages by providing a system and method for real-time communication to multiple remote users over a computer network, for example the world wide web, data generated or acquired by computer application programs in real-time. The invention is particularly advantageous in web-based applications, providing a framework within which interactive web-based applications can be designed to disseminate information in true real-time. Based on a “subscribe-publish” architecture, the invention avoids unnecessary polling and user requests. Moreover, the system of the invention delivers only information content which has changed, thus avoiding the waste of system resources inherent in batch-based systems.

The invention accomplishes this by providing an open standards-based framework, referred to herein as a “web application event framework” or WAEF, which allows software developers to convert traditional client/server interactive applications into robust, fully functional web-enable products. The system and method of the invention substantially enhances the performance and deployment of web-enabled applications, and allows software developers to create new applications based on true real-time interactivity which is unavailable using prior art web-based communications frameworks.

According to the invention, a web server creates proxies which establish persistent listeners between a web browser and an application server. The web browser hosts the listener application, as well as a publisher application and the web application event framework, preferably in different HTML frames.

In the preferred embodiment, the method of the invention comprises the following steps:

a. The user issues a request for the URL of a designated web page through a conventional web browser;

b. The WAEF start controller creates a Session Object which establishes a persistent connection between the user's web browser and the web server and maintains a session state, for example connection speed and connection state;

c. The session object creates one or more application instance objects, depending upon which application(s) have been requested by the user, each of which maintains an application state specific to the functionality of the associated application;

d. The WAEF application creates a listener by registering a callback with the application server, to listen for a specific set of events within the application;

e. Each application event is published to the web server through the established session object connection;

f. The listener frame receives the event and notifies the application frame using native browser language (for example JavaScript, DHTML, HDML, WML, WAPScript, VBScript etc.) that an event has occurred; and

g. The WAEF application code notifies the user that the event has occurred.

To publish events occurring at a remote computer through the WAEF application:

h. The user submits an event using any standard platform-dependent method (for example HTTP POST or GET) in the web environment;

i. The event data is interpreted by the web server and passed to a WAEF generator resident on the application server; and

j. The WAEF generator creates WAEF events for all users who have established a listener relating to the application in which the event has occurred, and communicates the event to the users through the application listener object(s).

Thus, applications designed based on the invention stream application events in real-time to all users who have established a listener relating to the application in which the event has occurred. This allows web-based business processes to occur instantly across the network, providing advantages such as: customer orders are instantly confirmed, scheduled, processed and reserved from inventory; inventory levels are reduced through real-time order processing and production scheduling; full auctioning capability; instant online customer support capability; true real-time collaboration and communication; perpetual availability of up-to-date company information (stock levels, orders, cash position, field rep location, project status, scheduling changes etc.); and instant consumer-based transactions, such as reservations, stock quotes etc.

The present invention thus provides a method of real-time communication between a remote station and an application server over a computer network, comprising the steps of: a. in response to a request from the remote station, creating a persistent connection between the remote station and a web server; b. in response to a selection from the remote station, creating at least one application instance object which maintains an application state specific to a functionality of an application on the application server; c. creating a listener to receive any event within a specified set of events; and d. in response to the occurrence of an event within the set of events, publishing the event to each listener associated with the application, for communication to the remote station.

Further aspects of the method of the invention include the step of: e. notifying the remote station that the event has occurred; and where the event occurs at a remote station the step of publishing an event includes the substeps of: a. communicating the event from the remote station at which the event occurs to the web server; and b. communicating event data representing the event to the application server.

The present invention further provides a system for real-time communication between a remote station and an application server over a computer network, comprising: a computer with a browser having a user interface, for communicating with a remote server and for creating a local listener to receive an event, an application server remote from the computer, supporting at least one application program, and a web server for creating a session object which maintains a persistent connection with the computer, at least one application instance object which maintains an application state specific to a functionality of an application on the application server, and a remote listener for receiving an event within a specified set of events occurring in the application program; wherein in response to the occurrence of an event within the set of events, the event is published in real-time to the local listener associated with the application in which the event occurred, and the browser is thereby provided with data to update the user interface.

In further aspects of the system of the invention: the browser accepts the data to update the user interface without refreshing the user interface; the listener notifies the remote station that an event has occurred; and/or the computer comprises software for publishing an event which occurs at the computer and communicating the event from the computer to the web server, and the web server comprises software for communicating data representing the event to the application server.

The present invention further provides a computer program product for use with a computer, the computer program product comprising a computer usable medium having computer readable program code means embodied in said medium for real-time communication between a remote station and an application server over a computer network, said computer program product having a. computer readable program code means for, in response to a request from a remote station, creating a persistent connection between the remote station and a web server; b. computer readable program code means for, in response to a selection by the remote station, creating at least one application instance object which maintains an application state specific to a functionality of an application on the application server; c. computer readable program code means for creating a listener to receive any event within a specified set of events; and d. computer readable program code means for, in response to the occurrence of an event within the set of events, publishing the event to each listener associated with the application, for communication to the remote station.

Further aspects of the computer program product of the invention include computer readable program code means for notifying the remote station that the event has occurred; and/or computer readable program code means for communicating an event from a remote station to the web server and communicating event data representing the event to the application server.

### BRIEF DESCRIPTION OF THE DRAWINGS

In drawings which illustrate by way of example only a preferred embodiment of the invention,

FIG. 1 is a block diagram of a typical prior art web-based communication system,

FIG. 2 is a workflow diagram of an overview of the system and method of the invention,

FIG. 3 is a schematic diagram illustrating the high level architecture of the system and method of the invention, and

FIG. 4 is schematic diagram illustrating the activities of the components of a preferred embodiment of the invention.

### DETAILED DESCRIPTION OF THE INVENTION

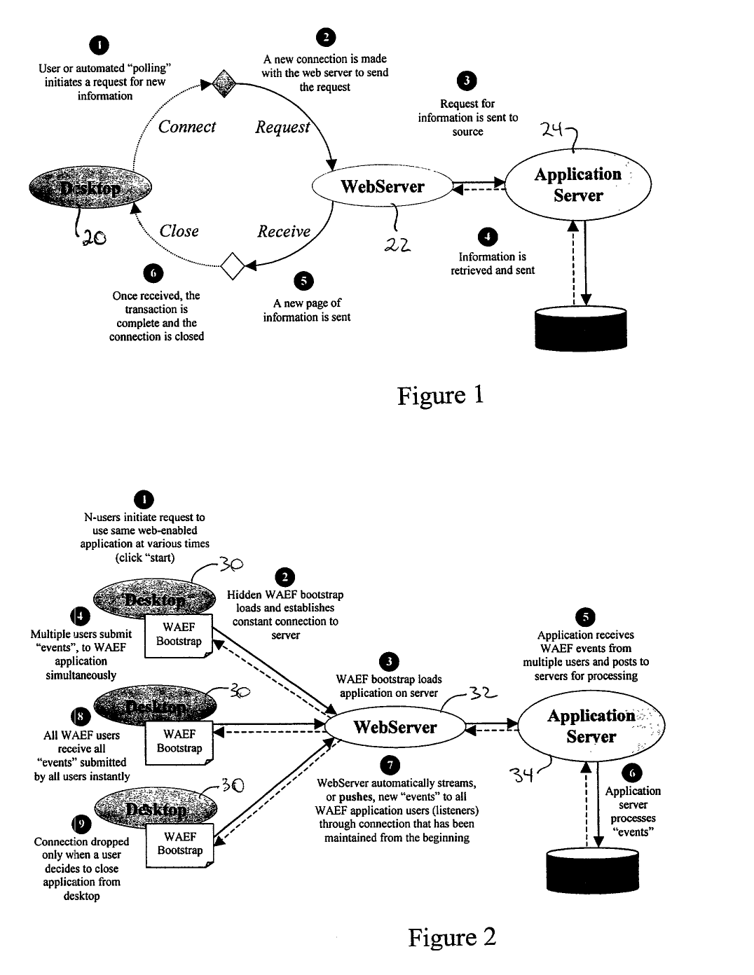

FIG. 1 illustrates a typical prior art interactive web-based communications system. A user at a remote computer station 20 requests information through a web server 22, which passes the request to a source application server 24, which may for example be located at an enterprise head office. The user request may be manually driven or automatic. When the request is made a connection with the application server is established, the information is retrieved from the source application server 24, and an entire page is transmitted back to the user through the web server 22. When the page has been downloaded the transaction is complete and the connection with the application server 24 is closed. To maintain up-to-date information this process is repeated frequently, each time establishing a new connection with the source application server 24 and retrieving a complete page of information before the connection is closed.

An overview of the invention is illustrated in FIG. 2. According to a preferred embodiment of the invention, each user initially establishes a connection with the web server 32 and selects the application(s) which are of interest to the user. The invention establishes a persistent connection with the application server 34, which remains open until closed by the user. Application events are transmitted in real-time from each of the multiple users' computers 30 to the application server 34, which processes the events and automatically streams or “publishes” each new event to all users who have selected the application in which the event has occurred. At the users' computers 30 the new application events are continually downloaded into an open web page which, rather than being refreshed each time new information is received, merely continues to add new event data to the open page.

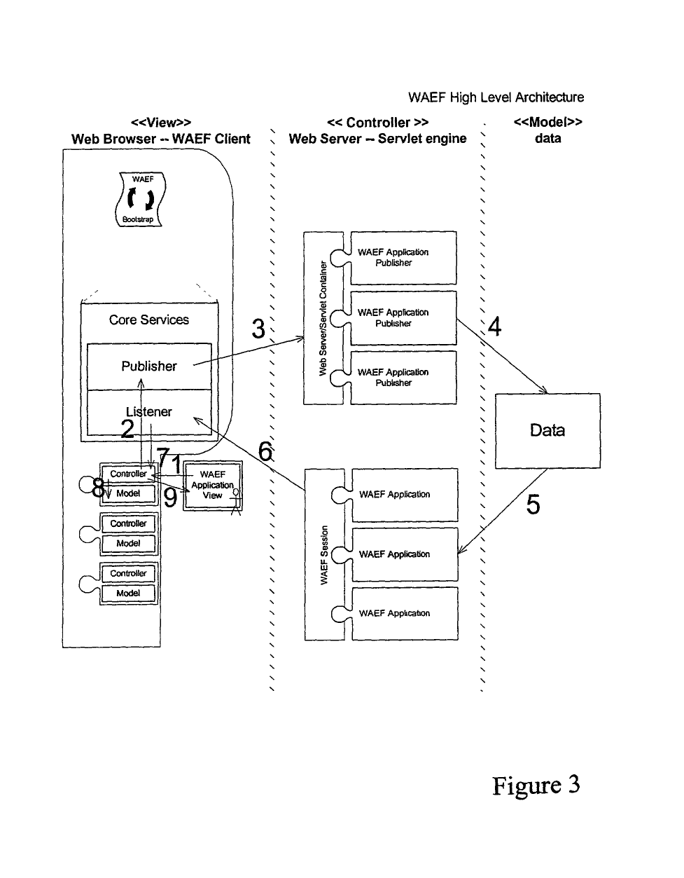

FIG. 3 illustrates the high level architecture of a preferred embodiment of the invention. The step numbers appearing below correspond to the numbered steps in FIG. 3.

1. The user interacts with the WAEF application user view to generate a new event within an open application, which creates method calls to the WAEF application controller resident on the user's computer 30.

2. Changes within the application are identified by the WAEF application controller and published to the web server through client publisher software.

3. The WAEF application publisher controller resident on the web server 32 receives the change request and generally a) validates the request as properly formatted, and b) verifies that the request is authorized to make the change.

4. Business rules are applied to the request as specified by the application in which the change has been made, and changes to the data are made at the application server 34.

5. The WAEF application recognizes changes in the data and prepares a function in native browser language, for example JavaScript by way of example, which includes the new data as parameters to the function.

6. The WAEF Session Object wraps the JavaScript function in as a WAEF event and transmits the WAEF event to the listener running in the user's web browser.

7. The WAEF listener validates the incoming WAEF events and executes the function in the WAEF application controller space in the users' browser.

8. The WAEF application controller updates the local model.

9. The WAEF application controller function “paints” the various elements and/or data into the WAEF application user view.

Steps 5 to 9 are repeated until the desired effect on the client's user interface is reflected for the data change recognized by the WAEF application in step 5.

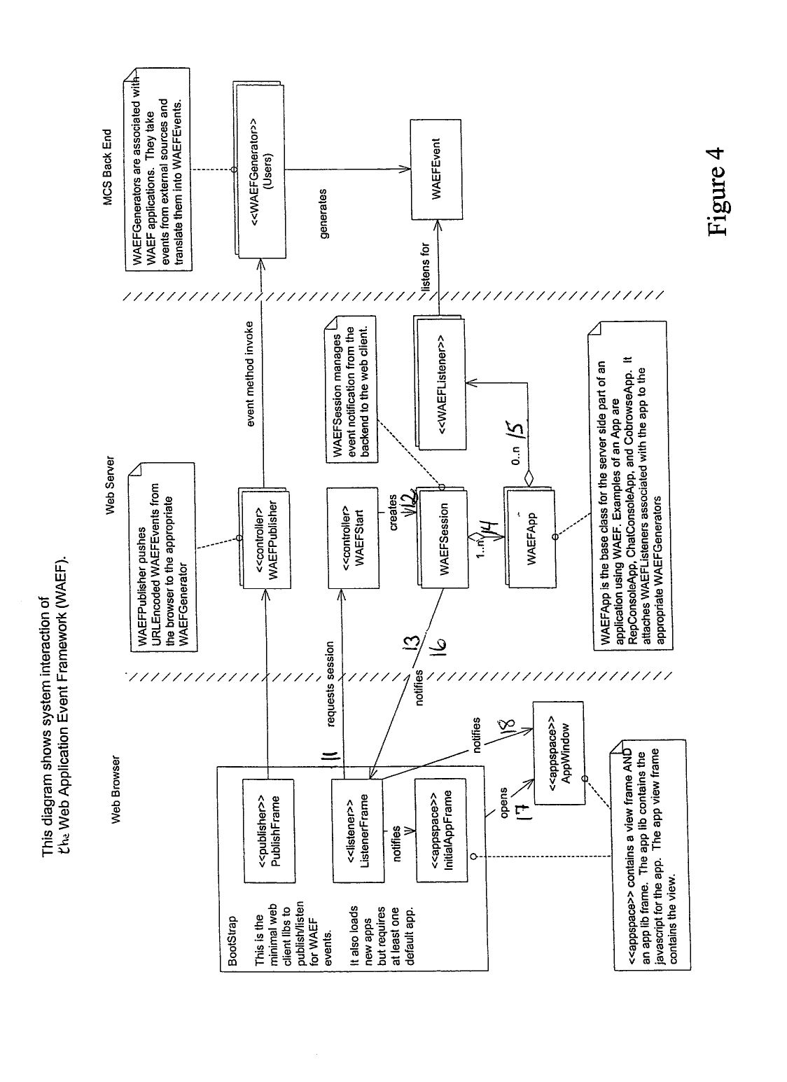

FIG. 4 illustrates the WAEF system interaction according to a preferred embodiment of the invention. WAEF is composed of three primary sections divided between web browser on the user's computer 30, web server 32 and application server 34. The application server 34 receives events from other business applications or other WAEF applications. The web server 32 creates application proxies which create persistent listeners between the web browser and the application server. The web browser hosts the WAEF listener and publisher as well as the WAEF client application(s). As shown in FIG. 4 the listener, publisher and client application(s) are preferably hosted in separate HTML frames. FIG. 4 illustrates the system interaction in the context of HTML and JavaScript web browsers, however it will be appreciated that the invention has application beyond HTML and JavaScript web browsers and is a generalized framework for event-enabling thin clients such as web browsers, WAP phones, etc.

In FIG. 4 the following steps occur, the numbers appearing below corresponding to the numbered steps in FIG. 4:

11. The user requests a WAEF application from the browser by requesting the URL of the WAEF application, as they would any web page.

12. The WAEF start controller creates a session object which establishes a persistent connection between the web browser and the web server 32 and maintains session state, such as connection speed, and connection state.

13. The WAEF session object creates one or more application instance objects, depending on which applications have been requested, which maintain application state, which is specific to the business functionality of the application.

14. The WAEF application creates a listener by registering a call back with the application server 34 to listen for a specific set of events.

15. WAEF events are published to the web server 32 through the established session object connection.

16. The listener frame notifies the application frame using native browser language, such as JavaScript, DHTML, HDML, WML, WAPScript, VBScript etc., that an event has occurred. The WAEF application code then executes appropriate scripting to notify the user.

For publishing events from a WAEF application:

17. The user submits an event using standard platform dependant methods, such as HTTP POST or GET in the web environment.

18. The event data is interpreted by the web server and passed to the WAEF generator on the application server 34.

19. The WAEF generator creates WAEF events for all “interested” listeners, which are delivered to the users' computers 30 through the application listener(s).

A preferred embodiment of the invention has been described by way of non-limiting example only. Those skilled in the art will appreciate that certain modifications and adaptations may be made without departing from the scope of the invention as claimed.

We claim:

1. A method of real-time communication between a remote station and an application server over a computer network, comprising the steps of:
a. in response to a request from the remote station, creating a persistent connection between the remote station and a web server;
b. in response to a selection from the remote station, creating at least one application instance object which maintains an application state specific to a functionality of an application on the application server;
c. creating a listener to receive any event within a specified set of events; and
d. in response to the occurrence of an event within the set of events, publishing the event to each listener associated with the application, for communication to the remote station.

2. The method of claim 1 including the step of:
e. notifying the remote station that the event has occurred.

3. The method of claim 1 in which the event occurs at a remote station and the step of publishing an event includes the substeps of:
a. communicating the event from the remote station at which the event occurs to the web server; and
b. communicating event data representing the event to the application server.

4. A system for real-time communication between a remote station and an application server over a computer network, comprising:
a computer with a browser having a user interface, for communicating with a remote server and for creating a local listener to receive an event,
an application server remote from the computer, supporting at least one application program, and
a web server for creating
a session object which maintains a persistent connection with the computer,
at least one application instance object which maintains an application state specific to a functionality of an application on the application server, and
a remote listener for receiving an event within a specified set of events occurring in the application program;
wherein in response to the occurrence of an event within the set of events, the event is published in real-time to the local listener associated with the application in which the event occurred, and the browser is thereby provided with data to update the user interface.

5. The system of claim 4 in which the browser accepts the data to update the user interface without refreshing the user interface.

6. The system of claim 5 wherein the listener notifies the remote station that an event has occurred.

7. The system of claim 4 in which the computer comprises software for publishing an event which occurs at the computer and communicating the event from the computer to the web server, and the web server comprises software for communicating data representing the event to the application server.

8. A computer program product for use with a computer, the computer program product comprising a computer usable medium having computer readable program code means embodied in said medium for real-time communication between a remote station and an application server over a computer network, said computer program product having
a. computer readable program code means for, in response to a request from a remote station, creating a persistent connection between the remote station and a web server;
b. computer readable program code means for, in response to a selection by the remote station, creating at least one application instance object which maintains an application state specific to a functionality of an application on the application server;
c. computer readable program code means for creating a listener to receive any event within a specified set of events; and
d. computer readable program code means for, in response to the occurrence of an event within the set of events, publishing the event to each listener associated with the application, for communication to the remote station.

9. The computer program product of claim 8 including computer readable program code means for notifying the remote station that the event has occurred.

10. The computer program product of claim 8 including computer readable program code means for communicating an event from a remote station to the web server and communicating event data representing the event to the application server.
